(19) United States
(12) Patent Application Publication
(10) Pub. No.: US 2004/0163072 A1
(43) Pub. Date: Aug. 19, 2004

(54) Electronic design automation with automatic generation of hardware description language (HDL) code

(75) Inventor: Yinon Levy, Raanana (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: ROYAL DESIGN LTD.

(21) Appl. No.: 10/779,687

(22) Filed: Feb. 18, 2004

Related U.S. Application Data
(60) Provisional application No. 60/447,686, filed on Feb. 19, 2003.

(51) Int. Cl. G06F 9/44; G06F 17/50

(52) U.S. Cl. 717/106; 716/3

(57) ABSTRACT

A design automation system allows entry of designs and converts the designs to register transfer level (RTL) hardware description language (HDL). Presenting the designer with a selection of flexible, customizable subsystems for inclusion in the design facilitates design entry, the subsystems being modified via menus, computerized forms or a graphic user interface (GUI) presented to the designer, or via text in the form of a high-level language. The menus, computerized forms, or high-level language text capture the specific parameters or properties for each instantiation of each subsystem, and the system automatically generates RTL HDL code for the design.

This is a continuation-in-part of U.S. Provisional Patent Application No. 60/447,686, filed Feb. 19, 2003

### FIELD AND BACKGROUND OF THE INVENTION

The present invention is in the field of electronic design automation (EDA) and relates to a system for automatically generating hardware description language (HDL) code, and, more particularly, to a system that allows a user to write high-level, procedural descriptions of electronic hardware, which the system automatically translates into a structural, synthesizable, register transfer level (RTL) HDL description of the target system, or, alternatively, presents a user with a selection of design entities for use in designing a target system, and, for each instantiation of each design entity, collects from the user, via menus, computerized forms, databases, files, or other mechanisms, the specific information needed to adjust the RTL HDL code produced for the specific instantiation of the design entity so as to be suitable to the user's needs.

As used herein with reference to HDL, the term “synthesizable” means that the HDL is suitable for automated synthesis of electronic hardware.

Industry standard HDLs include Very High Speed Integrated Circuit (VHSIC) HDL (VHDL) and Verilog HDL. Newer HDLs include System Verilog and SystemC. The present invention is suited to application with VHDL, Verilog HDL, System Verilog, or SystemC, but the present invention is not restricted to application with any particular version of HDL.

Various attempts have been made to simplify and hasten the process of entering designs into electronic design automation (EDA) systems. U.S. Pat. No. 6,477,683 presents a system for flexibly designing data processors, the system producing synthesizable HDL code for the target data processors automatically, based on a description of the instructions the target data processor is to be able to execute. However, the system of U.S. Pat. No. 6,477,683 does not address general-purpose electronic hardware.

In general, not all legal HDL code is suitable for the synthesis of electronic devices. Most synthesis tools that accept HDL as input require that the HDL be part of the subset of HDL known as RTL. RTL provides a detailed, structural description of the hardware.

The writing of HDL code, and especially RTL, is often a laborious, repetitive task subject to errors that are often hard to find. A designer who wishes to include a design entity such as a waveform generator or pattern recognizer must either enter the HDL code from scratch, or find an existing HDL description for the device. If the existing HDL description does not exactly satisfy the designer's needs, the existing HDL must be modified appropriately. Modifying HDL code, however, is a time-consuming and error-prone task.

There is thus a widely recognized need for, and it would be highly advantageous to have, a system that automatically produces HDL code for devices, taking into account the specific properties of each instantiation, and allowing designers to enter the specific properties in a convenient, easily documented manner, and at a high level, close to the specification of the design, thus minimizing the potential for error, as provided by the present invention.

### SUMMARY OF THE INVENTION

According to the present invention there is provided a system for design automation including: (a) a design entry system for selecting at least one design entity from a predetermined set of design entity templates; (b) a mechanism for accepting at least one respective property for at least one of the at least one design entity; and (c) a hardware description language generator operative to produce hardware description language corresponding to at least one of the at least one design entity according to the at least one respective property thereof.

Preferably, the system of further includes: (d) a preprocessor operative to accept a property generic to a plurality of design entities.

Preferably, in the system, the hardware description language includes hardware description language selected from the group consisting of VHDL, Verilog HDL, System Verilog, SystemC, and RTL HDL.

Preferably, in the system, the selecting of the design entity includes selecting via a mechanism selected from the group consisting of menus, computerized forms, and graphical user interfaces.

Preferably, in the system, the selecting of the design entity includes selecting via text.

Preferably, in the system, the text is embedded in HDL text.

Preferably, in the system, the text is HDL text.

Preferably, in the system, the text includes a predetermined character sequence operative to aid in automatic recognition of the text.

Preferably, in the system, the composing of the text is aided by a mechanism selected from the group consisting of menus, computerized forms, and graphical user interfaces.

Preferably, in the system, the text includes text selected from the group consisting of RxProperties statements, RxStatements, RxPhaseStatements, HitEvent statements, Trigger statements, RollingAction statements, SubRollingAction statements, StopProperty statements, PauseResumeProperty statements, and JumpProperty statements.

Preferably, in the system, the accepting of the property is via a mechanism selected from the group consisting of menus, computerized forms, and graphical user interfaces.

Preferably, in the system, the accepting of the property is via text.

Preferably, in the system, the text is embedded in HDL text.

Preferably, in the system, the text is HDL text.

Preferably, in the system, the. text includes a predetermined character sequence operative to aid in automatic recognition of the text.

Preferably, in the system, the at least one design entity includes a design entity selected from the group consisting of memory controllers, waveform generators, pattern recognizers, handshake controllers, telecommunication frame generators, telecommunication frame analyzers, sequencers, signal processors, text analyzers and serial stream analyzers.

Preferably, in the system, the property includes a property selected from the group consisting of a count limit, a count direction, a time interval, a count of clock cycles, a frequency, an array dimension, a reset procedure, synchrony of a reset signal, asynchrony of a reset signal, a condition for stopping an activity, a condition for jumping to a specified clock cycle within an event, a clock cycle within an event to jump to upon occurrence of a specified event, a condition for pausing an activity, a condition for resuming an activity, a condition for transfer from an action to a subtraction, behavior of a design entity upon completion of a subtraction, a return target, a specification that HitEvents are to proceed serially, a specification that HitEvents are to proceed in parallel, a specification that a HitEvent is to repeat upon completion, a specification of a number of times a HitEvent is to repeat, a successive wait condition, an until condition, a range condition, a wait-on condition, a wait accumulative condition, a wait-for condition, specification that a string expression is to be interpreted as a pattern trigger, and specification of a FalseAssignment procedure.

According to the present invention there is provided a method for design automation including the steps of: (a) selecting a respective design entity template, for at least one desired design entity, from a predetermined set of design entity templates; (b) selecting at least one respective property for at least one of the at least one design entity; and (c) generating hardware description.language corresponding to at least one of the at least one design entity according to the at least one respective property thereof.

Preferably the method further includes comprises the step of: (d) accepting a property generic to a plurality of design entities.

Preferably, in the method, the hardware description language includes hardware description language selected from the group consisting of VHDL, Verilog HDL, System Verilog, SystemC, and RTL HDL.

Preferably, in the method, the selecting of the design entity includes selecting via a mechanism selected from the group consisting of menus, computerized forms, and graphical user interfaces.

Preferably, in the method, the selecting of the design entity includes selecting via text.

Preferably, in the method, the text is embedded in HDL text.

Preferably, in the method, the text is HDL text.

Preferably, in the method, the text includes a predetermined character sequence operative to aid in automatic recognition of the text.

Preferably, in the method, composing of the text is aided by a mechanism selected from the group consisting of menus, computerized forms, and graphical user interfaces.

Preferably, in the method, the text includes text selected from the group consisting of RxProperties statements, RxStatements, RxPhaseStatements, HitEvent statements, Trigger statements, RollingAction statements, SubRollingAction statements, StopProperty statements, PauseResumeProperty statements, and JumpProperty statements.

Preferably, in the method, the accepting of the property is via a mechanism selected from the group consisting of menus, computerized forms, and graphical user interfaces.

Preferably, in the method, the accepting of the property is via text.

Preferably, in the method, the text is embedded in HDL text.

Preferably, in the method, the text is HDL text.

Preferably, in the method, the text includes a predetermined character sequence operative to aid in automatic recognition of the text.

Preferably, in the method, the at least one design entity includes a design entity selected from the group consisting of memory controllers, waveform generators, pattern recognizers, handshake controllers, telecommunication frame generators, telecommunication frame analyzers, sequencers, signal processors, text analyzers and serial stream analyzers.

Preferably, in the method, the property includes a property selected from the group consisting of a count limit, a count direction, a time interval, a count of clock cycles, a frequency, an array dimension, a reset procedure, synchrony of a reset signal, asynchrony of a reset signal, a condition for stopping an activity, a condition for jumping to a specified clock cycle within an event, a clock cycle within an event to jump to upon occurrence of a specified event, a condition for pausing an activity, a condition for resuming an activity, a condition for transfer from an action to a subtraction, behavior of a design entity upon completion of a subtraction, a return target, a specification that HitEvents are to proceed serially, a specification that HitEvents are to proceed in parallel, a specification that a HitEvent is to repeat upon completion, a specification of a number of times a HitEvent is lo repeat, a successive wait condition, an until condition, a range condition, a wait-on condition, a wait accumulative condition, a wait-for condition, specification that a string expression is to be interpreted as a pattern trigger, and specification of a FalseAssignment procedure.

According to the present invention there is provided a machine readable storage medium having stored thereon machine executable instructions, the execution of the machine executable instructions implementing a method for design automation, the method including the steps of: (a) selecting a respective design entity template, for at least one desired design entity, from a predetermined set of design entity templates; (b) selecting at least one respective property for at least one of the at least one design entity; and (c) generating hardware description language corresponding to at least one of the at least one design entity according to the at least one respective property thereof.

Preferably, in the machine readable storage medium, the method further includes tile step of: (d) accepting a property generic to a plurality of the design entities.

Preferably, in the machine readable storage medium, the selecting of the design entity includes selecting via text.

Preferably, in the machine readable storage medium, the composing of the text is aided by a mechanism selected from the group consisting of menus, computerized forms, and graphical user interfaces.

Preferably, in the machine readable storage medium, the text includes text selected from the group consisting of RxProperties statements, RxStatements, RxPhaseStatements, HitEvent statements, Trigger statements, RollingAction statements, SubRollingAction statements, StopProperty statements, PauseResumeProperty statements, and JumpProperty statements.

Preferably, in the machine readable storage medium, the accepting of the property is via text.

Preferably, in the machine readable storage medium, the at least one design entity includes a design entity selected from the group consisting of memory controllers, waveform generators, pattern recognizers, handshake controllers, telecommunication frame generators, telecommunication frame analyzers, sequencers, signal processors, text analyzers and serial stream analyzers.

Preferably, in the machine readable storage medium of claim 35, the property includes a property selected from the group consisting of a count limit, a count direction, a time interval, a count of clock cycles, a frequency, an array dimension, a reset procedure, synchrony of a reset signal, asynchrony of a reset signal, a condition for stopping an activity, a condition for jumping to a specified clock cycle within an event, a clock cycle within an event to jump to upon occurrence of a specified event, a condition for pausing an activity, a condition for resuming a activity, a condition for transfer from an action to a subtraction, behavior of a design entity upon completion of a subtraction, a return target, a specification that HitEvents are to proceed serially, a specification that HitEvents are to proceed in parallel, a specification that a HitEvent is to repeat upon completion, a specification of a number of times a HitEvent is to repeat, a successive wait condition, an until condition, a range condition, a wait-on condition, a wait accumulative condition, a wait-for condition, specification that a string expression is to be interpreted as a pattern trigger, and specification of a FalseAssignment procedure.

As used herein, the term “property” refers to a specific characteristic of a particular instantiation of a design entity. Examples of properties include, but are not limited to, frequencies, array dimensions, reset procedures, and conditions for stopping an activity. Numerical parameters, such as frequencies and array dimensions, are special cases of properties. Adjustment of the properties of an instantiation of a design entity aids in the customization of a design. Some properties, such as the name of a clock signal, or the polarity of a clock signal, may be generic to several design entities, and it is desirable to have the option of specifying such generic properties for several design entities all at once. Properties relevant to the present invention are discussed in more detail below.

According to the present invention there is provided a system and method for automatically generating synthesizable HDL code from a procedural description of electronic hardware. The system automatically translates the procedural description into structural, RTL HDL. Alternatively the system of the present invention presents a user with a selection of design entities for use in designing a target system, and, for each instantiation of each design entity, collects from the user, via menus, computerized forms, databases, files, or other mechanisms, the specific information needed to adjust the RTL HDL code produced for the specific instantiation of the design entity so as to be suitable to the user's needs.

The present invention successfully addresses the shortcomings of presently known electronic design automation systems by providing a mechanism that allows a user to enter electronic designs at a higher, i.e., more abstract, level than RTL HDL, and automatically translates the high-level design into RTL HDL. A high-level description of a design comes close to the specification of the design, thus easing the transformation of a specification into actual hardware, and reducing the likelihood of error. The automatic translation of high-level programs to lower-level programs has been used with much success in the software industry for many years, significantly reducing the effort required to produce and debug software. The present invention provides similar benefits to designers of electronic hardware. In addition, the present invention allows the user substantial control of the architecture of the hardware being designed. Thus, the user benefits from working at a high level without losing the ability to control the architecture of the design.

### BRIEF DESCRIPTION OF THE DRAWINGS

The invention is herein described, by way of example only, with reference to the accompanying drawings, wherein:

FIG. 1 is a schematic illustration of an electronic design automation system according to the present invention;

FIG. 2 is a schematic illustration of a text-based implementation of the present invention;

FIG. 3 is a listing of a source text file for use with a text-based implementation of the present invention;

FIG. 4a is the initial portion of a listing of RTL HDL output from a text-based implementation of the present invention for the source text presented in FIG. 3;

FIG. 4b is a continuation of the listing begun in FIG. 4a;

FIG. 5 illustrates schematically a preprocessor as seen by a user;

FIG. 6 illustrates schematically a menu for selecting a design entity;

FIG. 7 illustrates schematically a computerized form for selecting a design entity;

FIG. 8 illustrates schematically a graphical user interface for selecting a design entity;

FIG. 9 illustrates schematically a menu for accepting a property for a design entity;

FIG. 10 illustrates schematically a computerized form for accepting a property for a design entity;

FIG. 11 illustrates schematically a graphical user interface for accepting a property for a design entity;

FIG. 12 illustrates schematically a computer and a storage medium containing instructions to implement the present invention.

### DESCRIPTION OF THE PREFERRED EMBODIMENTS

The present invention is of a design automation system that can be used to capture system designs in an easy-to-use manner, and to produce synthesizable HDL code representing those system designs.

Specifically, the present invention allows a designer to write a description of an electronic system or subsystem in a concise, easily understood, and intuitive manner. The system of the present invention translates this description into RTL HDL.

In an alternative form, the present invention presents a designer with a choice of design entities for incorporation in the design. The design entities are presented to the designer as modifiable entities such as menus or forms on a computer display, which are selected by the use of other menus or computerized forms, such that the design entities may be modified in various ways to suit the needs of the designer. The modifications of the design entities are entered via one or more menus or computerized forms representing the properties of the design entities, and these properties are used to adjust the HDL that the design automation system of the present invention produces.

The principles and operation of a design automation system according to the present invention may be better understood with reference to the drawings and the accompanying description.

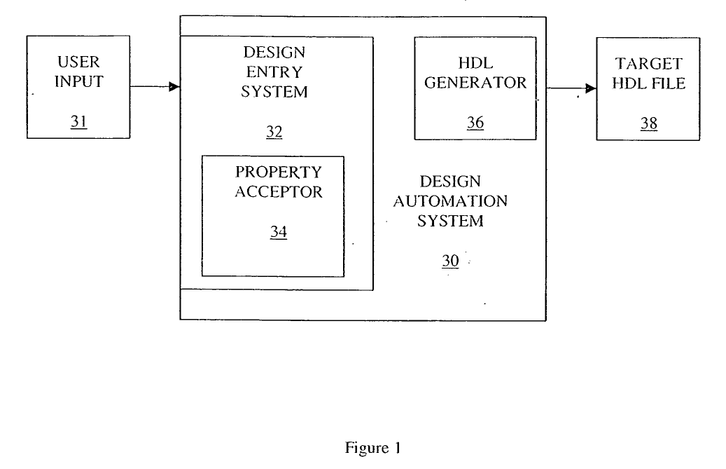

Referring now to the drawings, FIG. 1 illustrates schematically a design automation system 30 according to the present invention. User input 31 is captured by a design entry system 32. Design entry system 32 allows the user to specify design entities for inclusion in a design, and includes a property acceptor 34 which functions to modify design entities selected using design entry system 32. An HDL generator 36 automatically converts the design information gathered by design entry system 32 into an RTL HDL target text file 38 suitable for use with simulators, hardware synthesis tools, integrated circuit layout tools, and other systems that accept RTL HDL input.

Design entities which may be specified include, but are not limited to, memory controllers, waveform generators, pattern recognizers, handshake controllers, telecommunication frame generators, telecommunication frame analyzers, sequencers, signal processors, text analyzers and serial stream analyzers. A design entity may also be selected via a textual description of the actions taken by the design entity, and the conditions upon which those actions are taken. Actions can call subtractions, in a manner analogous to the use of subprograms in computer programs.

Properties include, but are not limited to, count limits; count direction, i.e., whether counting is to proceed upwards or downwards; time intervals; count of clock cycles; frequencies; array dimensions; reset procedures; whether a reset signal operates synchronously, i.e., only at an active clock edge, or asynchronously, i.e., without respect to a clock signal; conditions for stopping an activity; conditions for jumping to a specified clock cycle within an event; a clock cycle within an event to jump to upon the occurrence of a specified event; conditions for pausing an activity; conditions for resuming an activity; conditions for transfer from an action to a subtraction; and the behavior of a design entity upon completion of a subtraction, i.e., return to the point in the invoking action at which the subtraction was invoked, return to the start of the invoking action, return to a specified clock cycle within the invoking action, or termination of the invoking action. The point in an invoking action to which an invoked action returns control upon completion is referred to as a “return target”.

It is often desirable that a property have a default value which is selected automatically by the system when the user does not specify that property. The use of defaults is included in the present invention.

Procedures, such as reset procedures may be specified in the form of the actual procedure text, i.e., HDL code, or as a pointer, such as a name of a procedure.

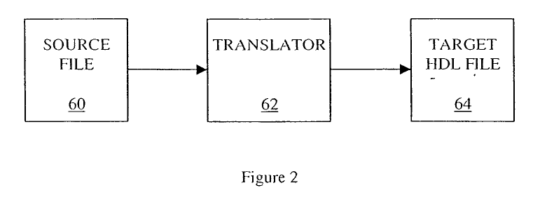

In one embodiment of the present invention, an abstract language is used by a designer to describe target systems at a high level of abstraction, the abstract language being suitable for automated translation into RTL HDL, although the abstract language itself is not necessarily valid HDL. As illustrated schematically in FIG. 2, the design automation system 30 of the present invention illustrated in FIG. 1 may be represented as a translator 62. The abstract language is presented to translator 62 as a source file 60, and translated by translator 62 into a target HDL file 64 that is valid RTL HDL. Translation of source file 60 into RTL HDL is accomplished in translator 62 by use of software techniques well-known to those skilled in the art. See for example, Steven Muchnick, Advanced Compiler Design and Implementation, Morgan Kaufmann, San Francisco, Calif., 1997, ISBN 1558603204, which is incorporated by reference for all purposes as if fully set forth herein. Also, see for example, Alfred V. Aho, Ravi Sethi, and Jeffrey D. Ullman, Compilers, Addison-Wesley, Reading, Mass., 1986, ISBN 0201100886, which is incorporated by reference for all purposes as if fully set forth herein.

Another embodiment of the present invention is similar to the above-mentioned embodiment, however, the abstract language for describing target systems used with the present invention is embedded within a source file 60 otherwise consisting of valid HDL, herein referred to as “substrate HDL”, and the system of the present invention recognizes, via keywords or key character sequences, portions of source file 60 that consist of the abstract language and translates those portions of source file 60 consisting of the abstract language into valid RTL HDL, producing a target file 64 including a mixture of substrate HDL from source file 60 and RTL HDL resulting from the translation. This embodiment has the significant advantage of allowing the translation of the abstract language to be done in the context of the substrate HDL.

Another embodiment of the present invention is similar to the above-mentioned embodiment, however, the abstract language for describing target systems is itself valid HDL, although not necessarily RTL HDL. This embodiment has the advantage of allowing source file 60 to undergo syntax checking and other debugging procedures using IHDL analysis tools that are naive to the abstract language of the present invention. The abstract language conforms to HDL because the abstract language takes the form of HDL procedure statements that include string parameters that describe the operation of the target system. In this manner, the non-HDL syntax of the abstract language is hidden from naive HDL tools. The advantage of being able to manipulate the abstract language as part of an HDL file is quite significant, because it saves the trouble of having to maintain the abstract language and the HDL separately in order to use the naive tools on the HDL portions of the design, and then recombine the abstract language and HDL to allow the system of the present invention to translate the abstract language into RTL HDL in the context of the substrate HDL.

String parameters may be represented in HDLs as string constants. Both string parameters and string constants are often referred to simply as “strings”, with the precise meaning being clear from the context. String constants in HDLs usually take the form of a sequence of characters enclosed within pairs of special characters, typically double quotes (“) or percent signs (%). Herein, as an aid to clarity, HDL string constants are enclosed within percent signs, for example, %string constant%. When a portion of a string constant, i.e., a substring, is presented herein, the substring is enclosed in percent signs, for example, %string%, for clarity, although the percent signs would not necessarily appear in the HDL. Individual HDLs have their own rules regarding the presentation of string constants, and the lexical conventions used herein are for illustrative purposes only, do not necessarily conform to the rules of any particular HDL, and are in no way intended to be considered limiting.

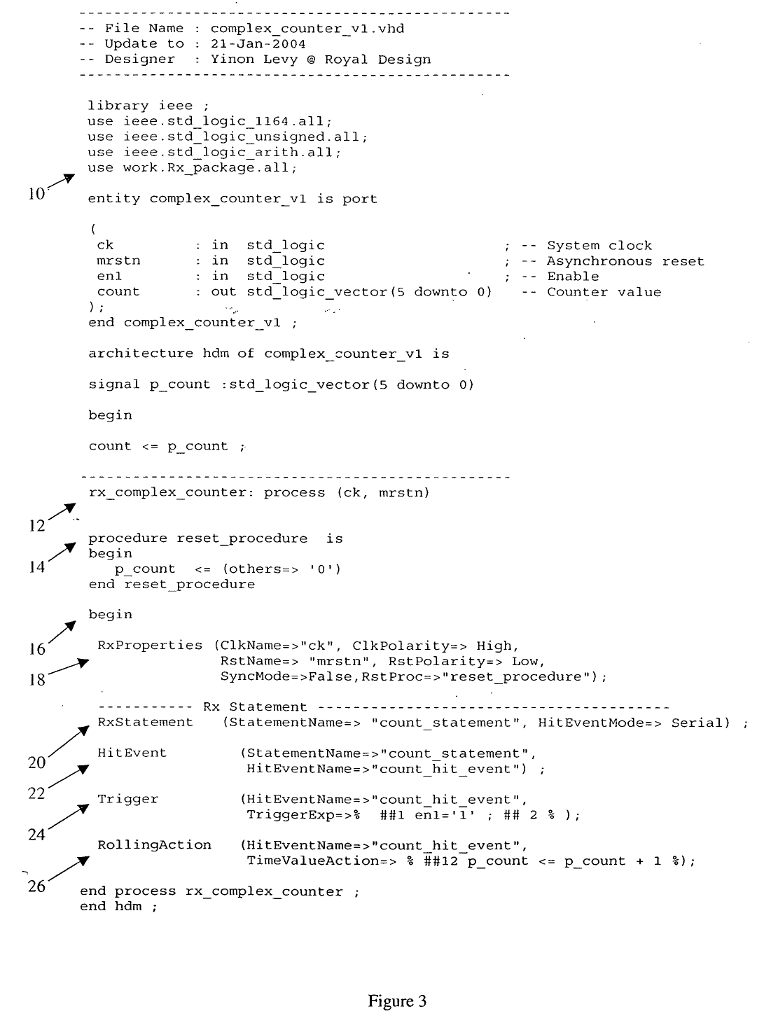

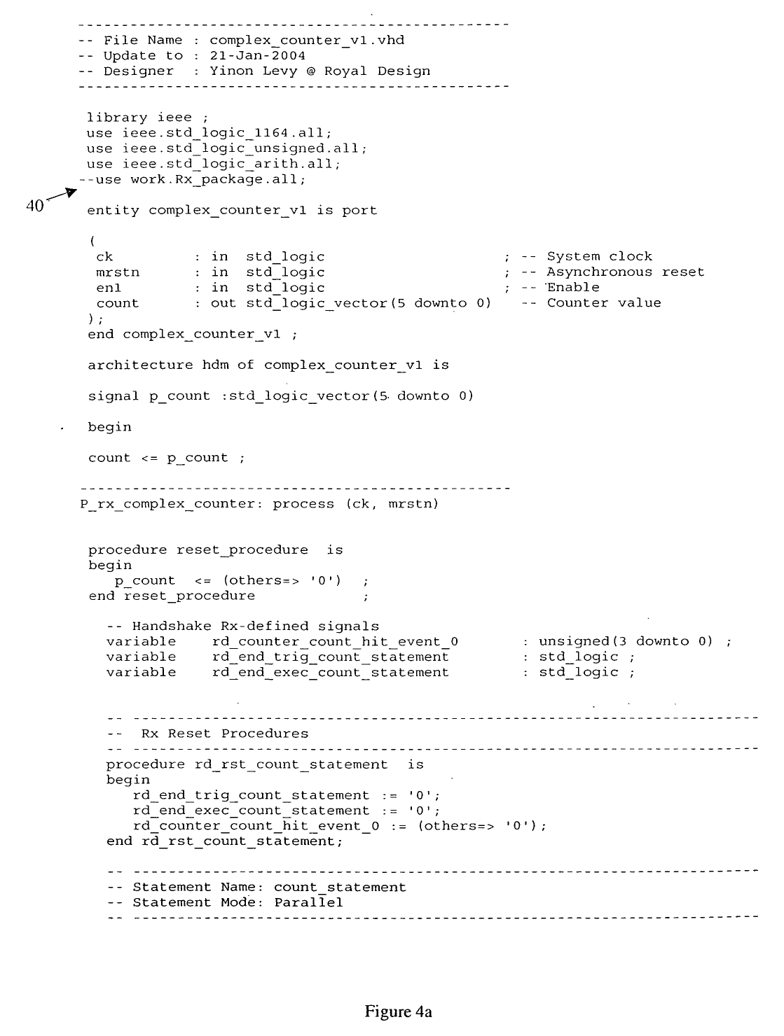

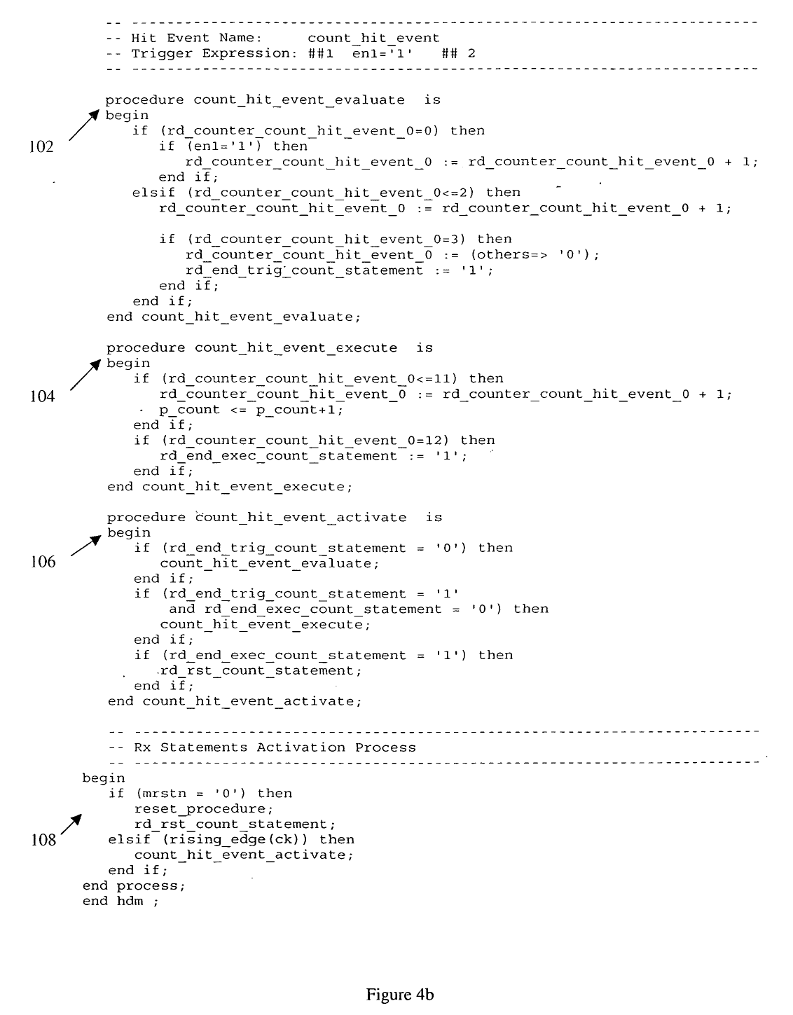

FIG. 3 includes a listing of an example source file 60 according to this embodiment of the present invention. The source file of FIG. 3 is valid HDL code, specifically, VHDL. The system of the present invention translates the source file of FIG. 3 into a target HDL file 64. FIGS. 4a and 4b include a listing of a target HDL file produced from the source file of FIG. 3 by a system according to the present invention.

To facilitate automatic recognition of text that is to be processed by the system of the present invention, this embodiment uses a character sequence included within such text. The character sequence “Rx” is used here for illustration, but other character sequences can be used for this purpose, and the use of other character sequences, or other mechanisms, for recognizing text that is to be processed by the system is within the scope of the present invention.

An HDL “use” statement 10 indicates a file, in this example named “Rx-package” and listed in the Appendix, which contains declarations of procedures and data types that are used in this embodiment of the present invention to allow a designer to express a design in a high-level, abstract language that is compatible with HDL. In this particular embodiment, these procedures include “RxProperties”, “RxStatement”, “HitEvent”, “Trigger”, and “Rolling-Action”. “Use” statement 10 of FIG. 3 is converted into a comment 40 in the listing of FIG. 4a by the system of the present invention because the file indicated therein is not relevant to the RTL HDL of the target HDL file.

An “RxProperties” statement (see Appendix) is used to indicate, for a block of HDL code, properties that are relevant to other statements written in the language of the present invention and to the electronic hardware corresponding to the block of HDL code.

An “RxStatement” statement (see Appendix) indicates that a hardware subsystem is to be created, and specifies a name for the hardware subsystem and whether the “HitEvent” components of the subsystem operate serially or in parallel. Optionally, an RxStatement specifies a condition causing the hardware subsystem created by the RxStatement to be reset.

A “HitEvent” statement (see Appendix) specifies the name of the “RxStatement” or “RxPhaseStatements” (see below) with which the “HitEvent” is associated, and the name of the HitEvent. The actions taken by hardware associated with a HitEvent are specified in “RollingAction” statements (see below). The conditions required for initiation of those actions are specified in “Trigger” statements (see below). Optionally, a HitEvent statement specifies a sequence of actions, subject to trigger conditions, to be taken upon completion of the HitEvent. Optionally, a HitEvent statement specifies a condition that will cause repetition of the HitEvent, and how many such repetitions are to be performed.

A “Trigger” statement (see Appendix) indicates the name of the HitEvent with which the Trigger is associated, the name of the Trigger, and a string expression specifying a sequence of conditions that must occur for the Trigger to be triggered. The string expression is composed of elements that permit expression of a variety of types of conditions. In a “successive wait condition” a condition, such as a particular signal having a particular logic value, must be true for a specified number of clock cycles. In an. “until condition”, the target system waits until a specified condition is true. A “range condition” is similar to a “successive wait condition”, but the number of clock cycles during which the condition must be true may be anywhere within a specified range, rather than restricted to a single value. In a “wait-on condition” the target hardware waits for a change in the value of a specified signal. In a “wait accumulative condition” the target hardware waits until a specified condition has been true during a specified number of clock cycles, the clock cycles not necessarily being contiguous. In a “wait-for condition” the target hardware simply waits for a specified number of clock cycles. These elements may be combined in a flexible manner to accommodate the needs of a particular design. Optionally, the string expression describing the trigger conditions may be specified as being of “pattern trigger” type, in which case failure of a portion of the trigger conditions to be met causes the target system to continue waiting for the trigger conditions to be met starting from the last successful trigger condition within the string expression, rather than starting the trigger recognition process from the beginning of the string expression. Optionally, a “FalseAssignment” procedure may be specified to be performed in the event that recognition of the trigger conditions specified by the string expression begins but fails before completion of the trigger conditions specified by the string expression.

A “RollingAction” statement indicates the name of the HitEvent with which the RollingAction is associated, the name of the RollingAction, and a string expression specifying a sequence of actions to be performed. Optionally, a Boolean expression may be specified; if this Boolean expression evaluates to “true”, the RollingAction is restarted.

A HitEvent thus specifies a hardware subsystem that includes a Trigger mechanism and a RollingAction mechanism. The Trigger mechanism, upon completion of a specified sequence of events, activates the RollingAction mechanism, which causes a sequence of events specified by string parameters of the RollingAction statement.

In FIG. 3, process statement 12 indicates that a target hardware system, named “rx_complex_counter”, is to be created. An HDL procedure definition 14 specifies a procedure named “reset_procedure” that is used to initialize the target hardware system.

A “begin” block opened by a begin statement 16 encloses high-level language statements 18, 20, 22, 24 and 26. These high-level language statements do not appear in the target HDL file of FIGS. 4a and 4b. These statements are converted by the system of the present invention into a corresponding sequence of RTL HDL statements, which are inserted into the target HDL file.

The function of the target hardware specified in this illustrative example is to wait for an input signal named en1 to be equal to 1 for one clock cycle, then wait two clock cycles, and then increment the six-bit register p_count by one for each of the following twelve clock cycles.

RxProperties statement 18 specifies that the target hardware will use the input signal “ck” as its system clock, that the clock polarity is high, i.e., the components of the target system register the clock on the rising edge of the clock, that the reset input signal is named “mrstn”, that the reset signal is active-low, and that reset is asynchronous, i e., independent of the clock signal, and that a reset signal initiates the procedure named “reset_procedure”.

RxStatement 20 specifies that RxStatement 20 is named “count_statement”, allowing other statements to refer to RxStatement 20. RxStatement 20 also specifies that the hit event mode for RxStatement 20 is serial, i.e., that the target hardware specified in each HitEvent statement associated with RxStatement 20 is to operate in the sequence that the HitEvent statements appear in the source file, rather than parallel, in which case all HitEvent statements associated with RxStatement 20 would begin operating together, at the same time. Automatically generated RTL HDL corresponding to RxStatement 20 is shown in FIGS. 4a and 4b, particularly begin block 108.

HitEvent statement 22 specifies that HitEvent statement 22 is associated with a statement named “count_statement”, this being the RxStatement 20 mentioned above. HitEvent statement 22 also specifies that HitEvent statement 22 is named “count_hit_event”, allowing other statements to refer to HitEvent statement 22. Automatically generated RTL HDL corresponding to HitEvent statement 22 is shown in FIG. 4b, procedure count_hit_event_activate 106.

Trigger statement 24 specifies that Trigger statement 24 is associated with a HitEvent statement named “count_hit_event”, this being HitEvent statement 22 mentioned above. Trigger statement 24 also specifies a trigger expression in the form of a string, % ##1 en1=‘1’; ## 2%. The trigger expression indicates the trigger conditions that the trigger hardware represented by the trigger expression will wait for, before triggering an associated action. The percent signs (%) serve to set the string off from the rest of the HDL text. Two pound signs, %##%, followed by a numerical expression and a logical expression indicates that the trigger hardware is to wait until the logical expression is true for that number of clock cycles. In this example. the substring %##1 en1=‘1’% indicates that the trigger hardware is to wait for the signal en1 to be logic I for one clock cycle. The semicolon %;% serves to separate portions of the trigger expression, which are tested for in sequence, from left to right. The substring %##2% indicates that the trigger hardware is to wait an additional two clock cycles. After the trigger conditions have been met, the trigger hardware will trigger the associated action. Automatically generated RTL HDL corresponding to Trigger statement 24 is shown in FIG. 4b, procedure count_hit_event_evaluate 102.

RollingAction statement 26 specifies that RollingAction statement 26 is associated with a HitEvent statement named “count_hit_event”, this being HitEvent statement 22 mentioned above. RollingAction statement 26 also specifies a TimeValueAction string, % ##12 p_count<=p_count+1%. The TimeValueAction string, with a syntax similar to that of the trigger expression discussed above, specifies actions to be taken by the hardware represented by the RollingAction statement 26 after the trigger conditions specified by Trigger statement 24 have been met. The substring %##12% indicates that the HDL expression that follows, %p_count<=p_count+1%, is to be repeated for twelve clock cycles. The expression %p_count<=p_count+1% indicates that the contents of six-bit register p_count is to be replaced with the sum of the-current contents of p_count and one. Automatically generated RTL HDL corresponding to RollingAction statement 26 is shown in FIG. 4b, procedure count_hit_event_execute 104.

Thus, the hardware specified by RxStatement 20 and associated statements 22, 24 and 26 in this simple illustrative example will wait for signal en1 to be true for one clock cycle, wait two more clock cycles, and then initiate counting in register p_count for twelve clock cycles. Whenever the actions specified in RollingAction statement 26 have been completed the hardware of the target system will repeat HitEvent statement 22, i.e., wait for the conditions specified in Trigger statement 24 to occur, and then perform the actions specified in RollingAction statement 26.

It will be apparent to those skilled in the art that the syntactic constructs used in this illustrative example can be used to represent other hardware. The application of these constructs to other hardware is within the scope of the present invention.

Although the example illustrated in FIG. 3 is written in VHDL, a substantially equivalent source file could be prepared in another HDL, such as Verilog HDL, System Verilog, or SystemC, and be processed similarly. Such use of other HDLs is included in the present invention.

The example illustrated in FIG. 3 shows only a portion of the versatility that may be achieved with a system according to the present invention. Following are some additional examples of the types of functionality that can be provided by an electronic design automation system according to the present invention.

An RxProperties statement may include specification, for hardware described by high-level language statements according to the present invention within a block of HDL code, of properties including, but not limited to, the name of the clock signal to be used by hardware within the block; the polarity of the clock signal, i.e., positive-edge or negative-edge; the name of a signal to initiate a reset procedure; the polarity of the reset signal, i.e., whether the reset procedure is initiated by the reset signal being at a high or low logic level; the name of the reset procedure; whether the reset is synchronous, i.e., the reset signal initiates the reset procedure only if the reset signal is active at the time of an active clock transition, or asynchronous, i.e. the reset signal initiates the reset procedure upon reaching an active logic level, regardless of the clock signal; a Boolean expression which must evaluate to “true” before the hardware described by the block is activated; and a Boolean expression, which, when evaluated to “true”, terminates the activity of the hardware described by the block.

RxPhaseStatements (see Appendix) indicate that hardware is to be created that operates sequentially, i.e., after the hardware specified by each RxPhaseStatement within a block has terminated its function, the hardware specified by the next RxPhaseStatement in the block is activated, subject to trigger conditions. An RxPhaseStatement specifies a name for the RxPhaseStatement, allowing other statements to refer to the RxPhaseStatement. An RxPhaseStatement also specifies whether “HitEvent” components of the subsystem created by the RxPhaseStatement operate serially or in parallel. Optionally, an RxPhaseStatement specifies a condition causing the hardware subsystem created by the RxPhaseStatement to be reset.

A SubRollingAction statement provides a mechanism for defining subtractions to be performed by a target system as part of a RollingAction. The relationship between a RollingAction and a SubRollingAction is analogous to the relationship in the field of computer software between a program and subprogram called by that program. A SubRollingAction may be the parent of a further SubRollingAction. A SubRollingAction statement specifies the name of the parent action, which may be a RollingAction or a SubRollingAction. A SubRollingAction statement further specifies its own name, allowing other statements to refer to the SubRollingAction. A SubRollingAction statement also specifies the behavior of the target hardware upon completion of the SubRollingAction, including, but not limited to, return to the point in the invoking RollingAction or SubRollingAction at which the current SubRollingAction was invoked, return to the start of the invoking RollingAction or SubRollingAction, return to a specified clock cycle within the invoking RollingAction or SubRollingAction, or termination of the, invoking RollingAction or SubRollingAction. Optionally, a SubRollingAction statement specifies a condition which must be true for the activity specified by the SubRollingAction to start, and, optionally, a numerical expression indicating a clock cycle at which to examine that condition. Optionally, a SubRollingAction statement specifies a Boolean expression which, if true, causes the SubRollingAction to restart. A SubRollingAction also specifies a string expression specifying a sequence of actions to be performed.

A StopProperty allows a designer to specify a condition under which target hardware specified by a Trigger statement, RollingAction statement or SubRollingAction statement will terminate activity. A StopProperty statement specifies the name of a Trigger statement, RollingAction statement or SubRollingAction statement, and a Boolean expression which, if true, will cause termination of the activity of the target hardware specified by the named Trigger statement, RollingAction statement or SubRollingAction statement. Optionally, a StopProperty statement specifies a numerical expression indicating a clock cycle during which the Boolean expression is evaluated.

A PauseResumeProperty statement allows a designer to set conditions upon which target hardware specified by a Trigger statement, RollingAction statement or SubRollingAction statement will pause or resume activity. A PauseResumeProperty statement specifies the name of a Trigger statement, RollingAction statement or SubRollingAction statement, and a pause Boolean expression which, if true, will cause a pause in the activity of the target hardware specified by the named Trigger statement, RollingAction statement or SubRollingAction statement. Optionally, a PauseResumeProperty statement specifies a numerical expression indicating a clock cycle during which the pause Boolean expression is evaluated. A PauseResumeProperty statement also specifies a resume Boolean expression which, if true, will cause a resumption in the paused activity of the target hardware specified by the named Trigger statement, RollingAction statement or SubRollingAction statement. Optionally, a PauseResumeProperty statement specifies a numerical expression indicating a clock cycle during which the resume Boolean expression is evaluated.

A JumpProperty statement allows a designer to specify conditions upon which target hardware specified by a Trigger statement, RollingAction statement or SubRollingAction statement will jump to a specified clock cycle. A JumpProperty statement specifies the name of a Trigger statement, RollingAction statement or SubRollingAction statement, a numerical expression specifying a clock cycle to which to jump, and a Boolean expression which, if true, will cause the target hardware specified by the named Trigger statement, RollingAction statement or SubRollingAction statement to jump to the specified clock cycle. Optionally, a JumpProperty statement specifies a numerical expression specifying a clock cycle at which the Boolean expression is to be evaluated.

The names given to the text statements used in the high-level language of this embodiment of the present invention are for illustrative purposes only, and similar text statements, regardless of any naming of those statements, are within the scope of the present invention.

In another embodiment of the present invention, the designer is presented with such devices as menus, computerized forms or a graphical user interface (GUI) which allow the designer to select design entities from a group of design entities, and establish the interconnections of the design entities. Optionally, a preprocessor establishes the basic properties of a design entity, such as the name of the design entity and input/output configurations. One or more specialized preprocessors are used to establish properties and configurations of particular types of design entities. allowing a designer to control the properties of groups of design entities all at once. This embodiment of the present invention also allows a designer to modify individual design entities in a flexible manner by the use of devices such as menus, computerized forms, or GUIs associated with each instantiation of each design entity.

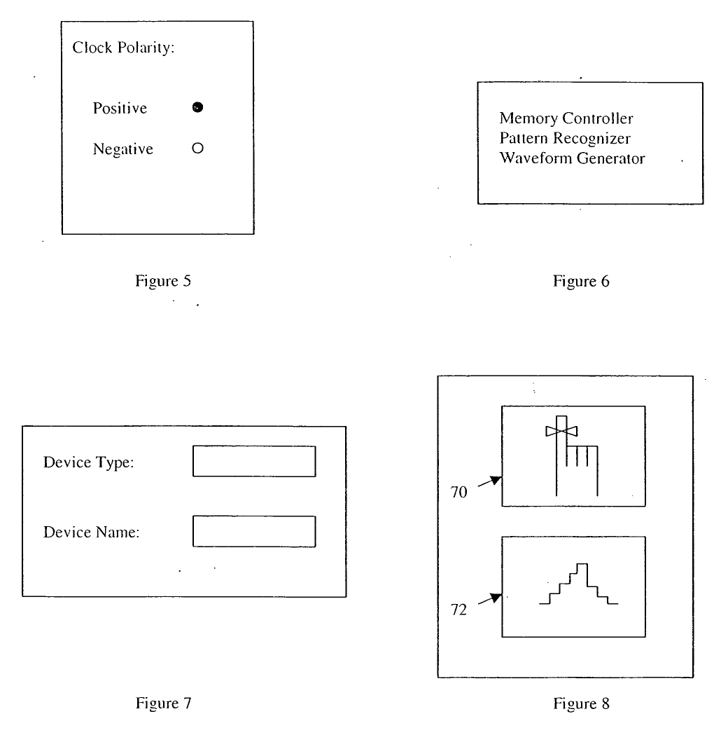

FIG. 5 illustrates schematically an example of a user interface for a preprocessor. In this example a user is able to select positive or negative clock polarity for a plurality of design entities by use of a pointing device, such as a mouse or trackball.

FIG. 6 illustrates schematically an example of a menu for selecting a design entity. This example menu allows a designer to choose a memory controller; pattern recognizer or waveform generator. Because currently used HDLs deal primarily with digital signals, the waveform generator referred to herein is a device for generating sequences of numerical values for presentation to a digital to analog converter. However, the present invention can be applied to HDLs that deal with analog signals as well.

FIG. 7 illustrates schematically an example of a computerized form for selecting a design entity. This example form provides spaces for a designer to enter the type of design entity, such as a pattern recognizer, and a name by which this particular instantiation of this design entity may be referred to.

FIG. 8 illustrates schematically an example of a graphical user interface for selecting a design entity. This example GUI allows a user to choose a memory controller 70 or a waveform generator 72.

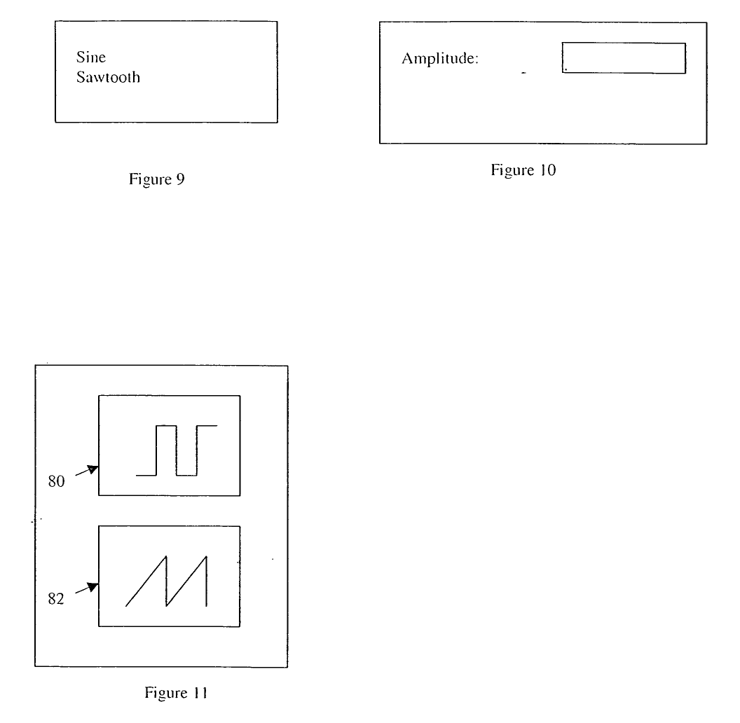

FIG. 9 illustrates schematically an example of a menu for specifying a property. This example menu, for use when a waveform generator has been selected as a design entity, allows a designer to choose between a sine wave and a sawtooth wave.

FIG. 10 illustrates schematically an example of a computerized form for specifying a property. This example form, for use when a waveform generator has been selected as a design entity, provides a space for a designer to enter the amplitude of the generated wave.

FIG. 11 illustrates schematically an example of a graphical user interface for specifying a property. This example GUI, for use when a waveform generator has been selected as a design entity, allows a user to choose between a square wave 80 and a sawtooth wave 82.

Many alterations and modifications of the user interface mechanisms illustrated in FIGS. 5, 6, 7, 8, 9, 10 and 11 may be made within the scope of the present invention. It is to be understood that these mechanisms are presented herein by way of illustration only, and are in no way intended to be considered limiting

By providing a designer with a mechanism to quickly and easily include such design entities as waveform generators, pattern recognizers, and memory controllers in a design, and automatically generating, HDL code for the design, the design automation system of the present invention allows quick and easy production of systems, and minimizes the probability of human error.

The features of the above embodiments of the present invention may be advantageously combined by using menus, computerized forms, graphical user interfaces, and other such mechanisms to aid in the composition of high-level language text. For example, a menu offering a choice of signals and other variables defined within a design can be combined with a menu offering a choice of symbolic operators would allow a designer to create high-level language text with a minimum of typing, and reduce the likelihood of error. The text thus created could also be modified by the user with text editing tools, allowing great flexibility.

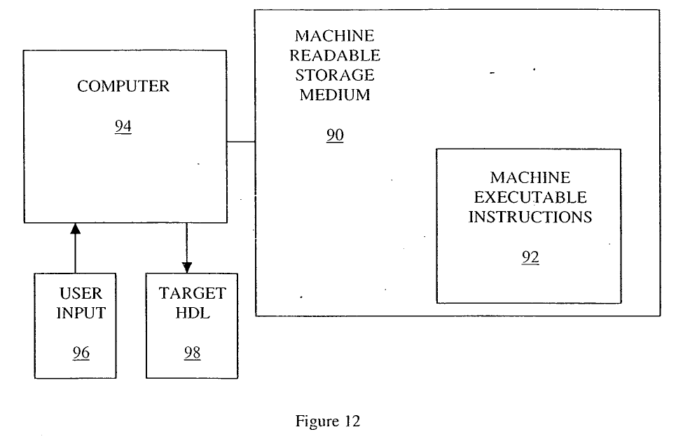

A design automation system 30 according to the present invention, as illustrated schematically in FIG. 1, may be implemented as illustrated schematically, by way of example only, in FIG. 12. A computer 94 executes machine executable instructions 92 stored in machine readable storage medium 90. Machine readable instructions 92 are selected, in accordance with that which is taught in the present invention, such that execution of machine readable instructions 92 by computer 94 is operative to translate user input 96 into target HDL 98.

Many alterations and modifications of the design automation system illustrated in FIG. 12 may be made within the scope of the present invention. It is to be understood that the example of FIG. 12 is presented herein by way of illustration only, and is in no way intended to be considered limiting.

While the invention has been described with respect to a limited number of embodiments, it will be appreciated that many variations, modifications and other applications of the invention may be made.

What is claimed is:

1. A system for design automation comprising:
(a) a design entry system for selecting at least one design entity from a predetermined set of design entity templates;
(b) a mechanism for accepting at least one respective property for at least one of said at least one design entity; and
(c) a hardware description language generator operative to produce hardware description language corresponding to at least one of said at least one design entity according to said at least one respective property thereof.

2. The system of claim 1, further comprising:
(d) a preprocessor operative to accept a said property generic to a plurality of said design entities.

3. The system of claim 1, wherein said hardware description language includes hardware description language selected from the group consisting of VHDL, Verilog HDL, System Verilog, SystemC, and RTL HDL.

4. The system of claim 1, wherein said selecting of said design entity includes selecting via a mechanism selected from the group consisting of menus, computerized forms, and graphical user interfaces.

5. The system of claim 1, wherein said selecting of said design entity includes selecting via text.

6. The system of claim 5, wherein said text is embedded in HDL text.

7. The system of claim 5, wherein said text is HDL text.

8. The system of claim 5, wherein said text includes a predetermined character sequence operative to aid in automatic recognition of said text.

9. The system of claim 5, wherein composing of said text is aided by a mechanism selected from the group consisting of menus, computerized forms, and graphical user interfaces.

10. The system of claim 5, wherein said text includes text selected from the group consisting of RxProperties statements, RxStatements, RxPhaseStatements, HitEvent statements, Trigger statements, RollingAction statements, SubRollingAction statements, StopProperty statements, PauseResumeProperty statements, and JumpProperty statements.

11. The system of claim 1, wherein said accepting of said property is via a mechanism selected from the group consisting of menus, computerized forms, and graphical user interfaces.

12. The system of claim 1, wherein said accepting of said property is via text.

13. The system of claim 12, wherein said text is embedded in HDL text.

14. The system of claim 12, wherein said text is HDL text.

15. The system of claim 12, wherein said text includes a predetermined character sequence operative to aid in automatic recognition of said text.

16. The system of claim 1, wherein said at least one design entity includes a design entity selected from the group consisting of memory controllers, waveform generators, pattern recognizers, handshake controllers, telecommunication frame generators, telecommunication frame analyzers, sequencers, signal processors, text analyzers and serial stream analyzers.

17. The system of claim 1, wherein said property includes a property selected from the group consisting of a count limit, a count direction, a time interval, a count of clock cycles, a frequency, an array dimension, a reset procedure, synchrony of a reset signal, asynchrony of a reset signal, a condition for stopping an activity, a condition for jumping to a specified clock cycle within an event, a clock cycle within an event to jump to upon occurrence of a specified event, a condition for pausing an activity, a condition for resuming an activity, a condition for transfer from an action to a subtraction, behavior of a design entity upon completion of a subtraction, a return target, a specification that HitEvents are to proceed serially, a specification that HitEvents are to proceed in parallel, a specification that a HitEvent is to repeat upon completion, a specification of a number of times a HitEvent is to repeat, a successive wait condition, an until condition, a range condition, a wait-on condition, a wait accumulative condition, a wait-for condition, specification that a string expression is to be interpreted as a pattern trigger, and specification of a FalseAssignment procedure.

18. A method for design automation comprising the steps of:
(a) selecting a respective design entity template, for at least one desired design entity, from a predetermined set of design entity templates;
(b) selecting at least one respective property for at least one of said at least one design entity; and
(c) generating hardware description language corresponding to at least one of said at least one design entity according to said at least one respective property thereof.

19. The method of claim 18, wherein the method further comprises the step of:
(d) accepting a property generic to a plurality of said design entities.

20. The method of claim 18, wherein said hardware description language includes hardware description language selected from the group consisting of VHDL, Verilog HDL, System Verilog, SystemC, and RTL HDL.

21. The method of claim 18, wherein said selecting of said design entity includes selecting via a mechanism selected from the group consisting of menus, computerized forms, and graphical user interfaces.

22. The method of claim 18, wherein said selecting of said design entity includes selecting via text.

23. The method of claim 22, wherein said text is embedded in HDL text.

24. The method of claim 22, wherein said text is HDL text.

25. The method of claim 22, wherein said text includes a predetermined character sequence operative to aid in automatic recognition of said text.

26. The method of claim 22, wherein composing of said text is aided by a mechanism selected from the group consisting of menus, computerized forms, and graphical user interfaces.

27. The method of claim 22, wherein said text includes text selected from the group consisting of RxProperties statements, RxStatements, RxPhaseStatements, HitEvent statements, Trigger statements, RollingAction statements, SubRollingAction statements, StopProperty statements, PauseResumeProperty statements, and JumpProperty statements.

28. The method of claim 18, wherein said accepting of said property is via a mechanism selected from the group consisting of menus, computerized forms, and graphical user interfaces.

29. The method of claim 18, wherein said accepting of said property is via text.

30. The method of claim 29, wherein said text is embedded in HDL text.

31. The method of claim 29, wherein said text is HDL text.

32. The method of claim 29, wherein said text includes a predetermined character sequence operative to aid in automatic recognition of said text.

33. The method of claim 18, wherein said at least one design entity includes a design entity selected from the group consisting of memory controllers, waveform generators, pattern recognizers, handshake controllers, telecommunication frame generators, telecommunication frame analyzers, sequencers, signal processors, text analyzers and serial stream analyzers.

34. The method of claim 18, wherein said property includes a property selected from the group consisting of a count limit, a count direction, a time interval, a count of clock cycles, a frequency, an array dimension, a reset procedure, synchrony of a reset signal, asynchrony of a reset signal, a condition for stopping an activity, a condition for jumping to a specified clock cycle within an event, a clock cycle within an event to jump to. upon occurrence of a specified event, a condition for pausing an activity, a condition for resuming an activity, a condition for transfer from an action to a subaction, behavior of a design entity upon completion of a subaction, a return target, a specification that HitEvents are to proceed serially, a specification that HitEvents are to proceed in parallel, a specification that a HitEvent is to repeat upon completion, a specification of a number of times a HitEvent is to repeat, a successive wait condition, an until condition, a range condition, a wait-on condition, a wait accumulative condition, a wait-for condition, specification that a string expression is to be interpreted as a pattern trigger, and specification of a FalseAssignment procedure.

35. A machine readable storage medium having stored thereon machine executable instructions, the execution of said machine executable instructions implementing a method for design automation, the method comprising the steps of:
(a) selecting a respective design entity template, for at least one desired design entity, from a predetermined set of design entity templates;
(b) selecting at least one respective property for at least one of said at least one design entity; and
(c) generating hardware description language corresponding to at least one of said at least one design entity according to said at least one respective property thereof.

36. The machine readable storage medium of claim 35, wherein the method further comprises the step of:
(d) accepting a property generic to a plurality of said design entities.

37. The machine readable storage medium of claim 35, wherein said selecting of said design entity includes selecting via text.

38. The machine readable storage medium of claim 37, wherein composing of said text is aided by a mechanism selected from the group consisting of menus, computerized forms, and graphical user interfaces.

39. The machine readable storage medium of claim 37, wherein said text includes text selected from the group consisting of RxProperties statements, RxStatements, RxPhaseStatements, HitEvent statements, Trigger statements, RollingAction statements, SubRollingAction statements, StopProperty statements, PauseResumeProperty statements, and JumpProperty statements.

40. The machine readable storage medium of claim 35, wherein said accepting of said property is via text.

41. The machine readable storage medium of claim 35, wherein said at least one design entity includes a design entity selected from the group consisting of memory controllers, waveform generators, pattern recognizers, handshake controllers, telecommunication frame generators, telecommunication frame analyzers, sequencers, signal processors, text analyzers and serial stream analyzers.

42. The machine readable storage medium of claim 35, wherein said property includes a property selected from the group consisting of a count limit, a count direction, a time interval, a count of clock cycles, a frequency, an array dimension, a reset procedure, synchrony of a reset signal, asynchrony of a reset signal, a condition for stopping an activity, a condition for jumping to a specified clock cycle within an event, a clock cycle within an event to jump to upon occurrence of a specified event, a condition for pausing an activity, a condition for resuming an activity, a condition for transfer from an action to a subaction, behavior of a design entity upon completion of a subaction, a return target, a specification that HitEvents are to proceed serially, a specification that HitEvents are to proceed in parallel, a specification that a HitEvent is to repeat upon completion, a specification of a number of times a HitEvent is to repeat, a successive wait condition, an until condition, a range condition, a wait-on condition, a wait accumulative condition, a wait-for condition, specification that a string expression is to be interpreted as a pattern trigger, and specification of a FalseAssignment procedure.
